(19) United States
(12) Patent Application Publication
(10) Pub. No.: US 2015/0256064 A1
(43) Pub. Date: Sep. 10, 2015

(54) METHOD, APPARATUS AND SYSTEM FOR A CHARGE PUMP WITH A SINGLE CAPACITOR AND MULTIPLE OUTPUTS

(71) Applicant: Texas Instruments Incorporated, Dallas, TX (US)

(72) Inventors: Susan Ann Curtis, Allen, TX (US); Karan Singh Jain, Dallas, TX (US); Harish Venkataraman, Wylie, TX (US)

(21) Appl. No.: 14/642,583

(22) Filed: Mar. 9, 2015

Related U.S. Application Data
(60) Provisional application No. 61/949,371, filed on Mar. 7, 2014.

(51) Int. Cl. H02M 3/07

(52) U.S. Cl. CPC H02M 3/073

(57) ABSTRACT

A circuit with a single capacitor and multiple outputs. The circuit reuses the same flying capacitor to charge multiple rails by timing the charging cycle sequentially, where the one rail is charged and then the charge pump switches to deliver power to the second rail.

### CROSS REFERENCES TO RELATED APPLICATIONS

This application claims priority from U.S. Provisional Patent Application No. 61/949,371 filed on Mar. 7, 2014, which is hereby incorporated by reference in its entirety.

### BACKGROUND OF THE INVENTION

1. Field of the Invention

Embodiments of the present invention generally relate to a method, apparatus and system for a charge pump with a single capacitor and multiple outputs.

2. Description of the Related Art

Existing charge pumps utilize a flying capacitor to charge a rail. If multiple output rails are to be created existing technology would require multiple flying capacitors and separate switches in the circuit to drive those capacitors. This adds complexity to the circuit and extra components to the system.

Therefore, there is a need for an improved multiple output rails circuit without the multiple flying capacitors.

### SUMMARY OF THE INVENTION

Embodiments of the present invention relate to a circuit with a single capacitor and multiple outputs. The circuit reuses the same flying capacitor to charge multiple rails by timing the charging cycle sequentially, where the one rail is charged and then the charge pump switches to deliver power to the second rail.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a circuit schematic for a charge pump with a single capacitor and multiple outputs.

### DETAILED DESCRIPTION

The proposed solution reuses the same flying capacitor to charge multiple rails by timing the charging cycle sequentially. As a result, the one rail is charged and then the charge pump switches to deliver power to the second rail.

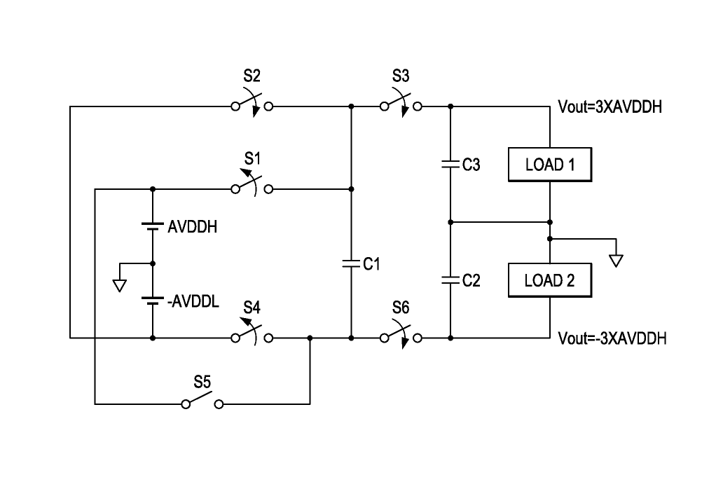

FIG. 1 is an embodiment of a circuit schematic for a charge pump with a single capacitor and multiple outputs. The circuit comprises −AVDDL, AVDDH, 6 switches S1-S6, 3 capacitors C1-C3, and 2 Loads. AVDDL is grounded on one side and coupled to S1 on the other. S1 is coupled to S2, S3 and C1 on one side and to AVDDH and S5 on the other. C1 is coupled to S1, S2, and S3 from one side and to S4, S5 and S6 on the other. S2 is coupled to −AVDDL and S4 on one side and S1, S3 and C1 on the other. −AVDDL is coupled to S2 and S4 on one side and grounded on the other. S3 is coupled to S1, S2 and C1 on one side and C2 and Load 1 on the other. S4 is coupled to S2 and −AVDDL and S5, S6 and C1 on the other side. S1 is coupled S1 and AVDDL and, on the other side, S4, S6 and C1. S3 is coupled to S1, S2 and C1 on one side and C2 and Load 1 on the other. S6 is coupled to S4, S5 and C1 on one side and C2 and Load 2 on the other. C2 is coupled to S6 and Load 2 on one side and on the other side to Ground. C3 is coupled to S3 and Load 1 on one side and on the other side to Ground. Load 1 is coupled to ground on one side and S3 and C3 on the other side. Finally, Load 2 is coupled to ground on one side and S6 and C2 on the other side.

The circuit in FIG. 1 charges one rail and then switches to the second rail. Each rail will be charged as needed and the charging cycle will alternate from one rail to the next. In one embodiment, even though the circuit in FIG. 1 shown one positive rail and one negative rail, several rails may be used. The system is not limited to this configuration but should include any number of outputs charged from one flying capacitor.

Moreover, this circuit design uses less external components and less internal switches. As a result, this circuit will have less external components, particularly only one flying capacitor required for the charging and less internal switches than would be necessary for the same number of outputs.

While the foregoing is directed to embodiments of the present invention, other and further embodiments of the invention may be devised without departing from the basic scope thereof, and the scope thereof is determined by the claims that follow.

What is claimed is:

1. A circuit with a single capacitor and multiple outputs, comprising:
−AVDDL, AVDDH, 6 switches S1-S6, 3 capacitors C1-C3, and 2 Loads;
wherein AVDDL is grounded on one side and coupled to S1 on the other;
S1 is coupled to S2, S3 and C1 on one side and to AVDDH and S5 on the other;
C1 is coupled to S1, S2, and S3 from one side and to S4, S5 and S6 on the other;
S2 is coupled to −AVDDL and S4 on one side and S1, S3 and C1 on the other;
−AVDDL is coupled to S2 and S4 on one side and grounded on the other;
S3 is coupled to S1, S2 and C1 on one side and C2 and Load 1 on the other;
S4 is coupled to S2 and −AVDDL and S5, S6 and C1 on the other side;
S1 is coupled S1 and AVDDL and, on the other side, S4, S6 and C1;
S3 is coupled to S1, S2 and C1 on one side and C2 and Load 1 on the other;
S6 is coupled to S4, S5 and C1 on one side and C2 and Load 2 on the other;
C2 is coupled to S6 and Load 2 on one side and on the other side to Ground;
C3 is coupled to S3 and Load 1 on one side and on the other side to Ground;
Load 1 is coupled to ground on one side and S3 and C3 on the other side; and
Load 2 is coupled to ground on one side and S6 and C2 on the other side.

2. The circuit with a single capacitor and multiple outputs of claim 1, wherein circuit is used in a charge pump.
